(19) United States
(12) Patent Application Publication
(10) Pub. No.: US 2013/0069858 A1
(43) Pub. Date: Mar. 21, 2013

(54) Adaptive communications system

(71) Applicant: Daniel O'Sullivan, Smithtown, NY (US)

(72) Inventor: Daniel O'Sullivan, Smithtown, NY (US)

(21) Appl. No.: 11/211,875

(22) Filed: Aug. 26, 2005

(51) Int. Cl. G09G 5/00

(52) U.S. Cl. CPC G09G 5/00
USPC 345/156

(57) ABSTRACT

This invention allows a system to monitor how quickly and accurately the user is responding via the input device. The input device can be a mouse, a keyboard, their voice, a touch-screen, a tablet PC writing instrument, a light pen or any other commercially available device used to input information from the user to the PBCD. Information is displayed on the PBCD screen based on how quickly and accurately the user is navigating with the input device.

### Cross-Reference to Related Application

This application for letters patent is a continuation of provisional patents for VoiceXL for VXML and VoiceXL for Processors applications filed on Aug. 25, 2004, Multimodal VoiceXL filed on Aug. 4, 2003, VoiceXL Provisional Patent Application filed on May 20, 2003, Easytalk Provisional Patent Application filed on May 9, 2001 and U.S. Pat. No, 5,493,608.

### STATEMENT REGARDING FEDERALLY SPONSORED RESEARCH OR DEVELOPMENT

Not Applicable

### BACKGROUND OF THE INVENTION

This invention is a modification to my U.S. Pat. No. 5,493,608 patent for a caller adaptive voice response system (CAVRS). The idea is to apply the same technology described in this patent and my subsequent provisional patent filings on the same subject matter, to visual based systems including Telephony Voice Systems, IVR Systems, PC's, tablet PC's, cell phones, PDA's, hand-held and auto devices and any other multimodal technology. I will call these devices Processor Based Computing Devices (PBCD's) and the actual patented Adaptive Process Technology will be known as APT.

### BRIEF SUMMARY OF THE INVENTION

This invention allows a system to monitor how quickly and accurately the user is responding via the input device. The input device can be a mouse, a keyboard, their voice, a touch-screen, a tablet PC writing instrument, a light pen or any other commercially available device used to input information from the user to the PBCD. Information is displayed on the PBCD screen based on how quickly and accurately the user is navigating with the input device.

### BRIEF DESCRIPTION OF THE DRAWINGS

FIG. 1 is Retail checking/savings account implementation, according to an embodiment.

FIG. 2 is Alternate speed audio file naming convention, according to an embodiment.

FIG. 3 is APT Implementation in VXML, according to an embodiment.

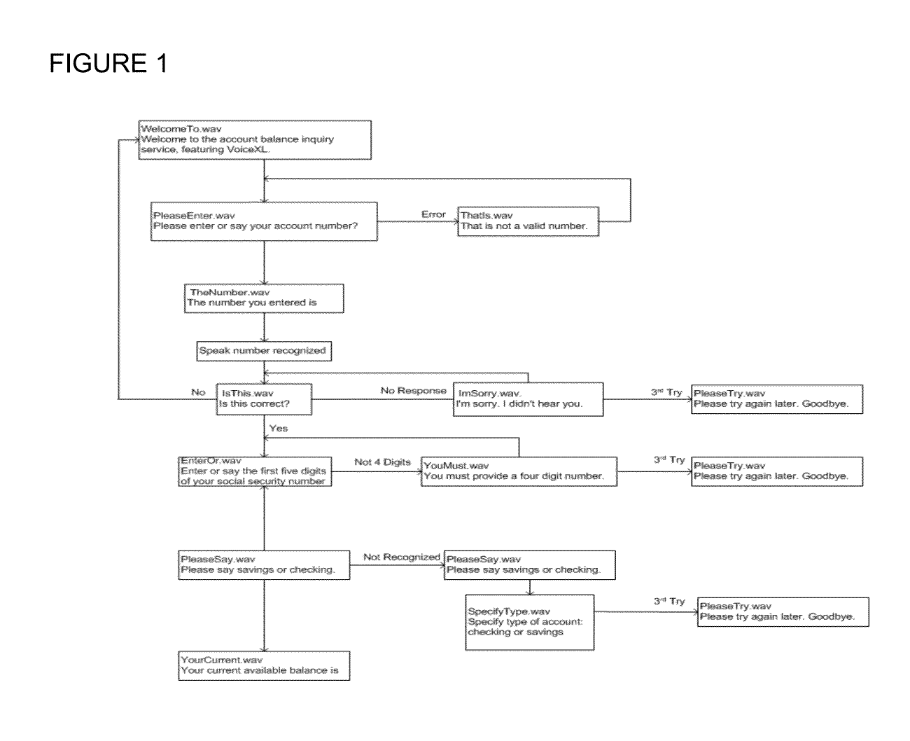

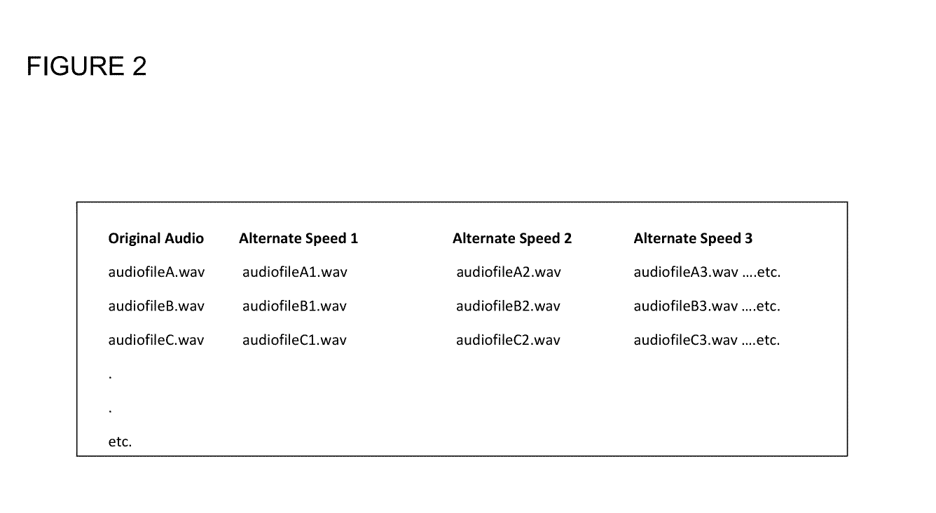

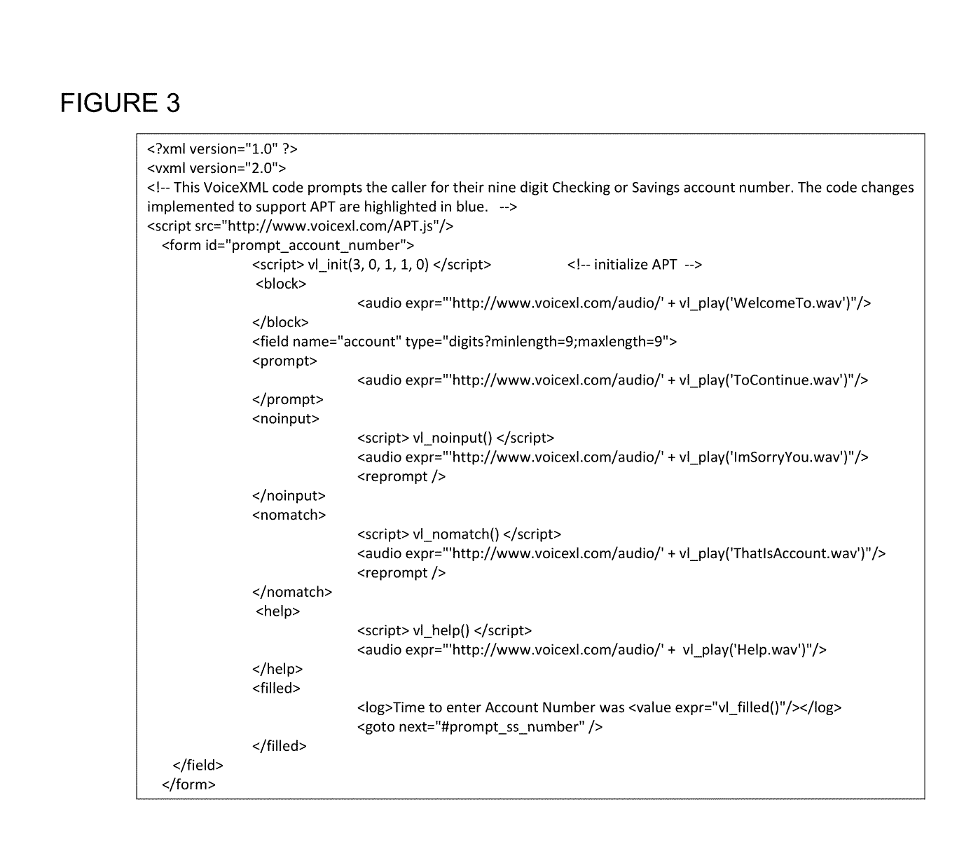

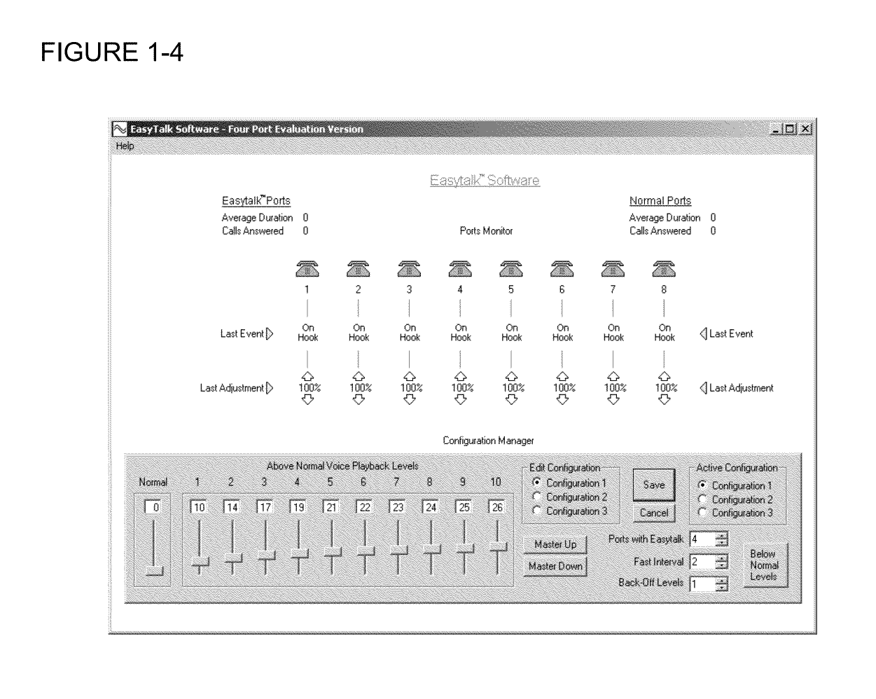

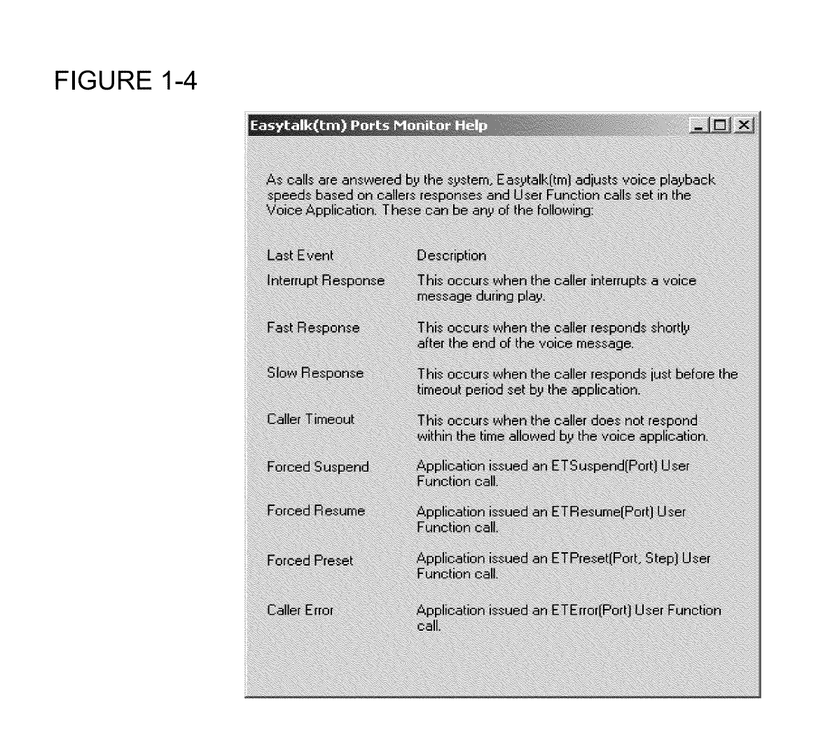

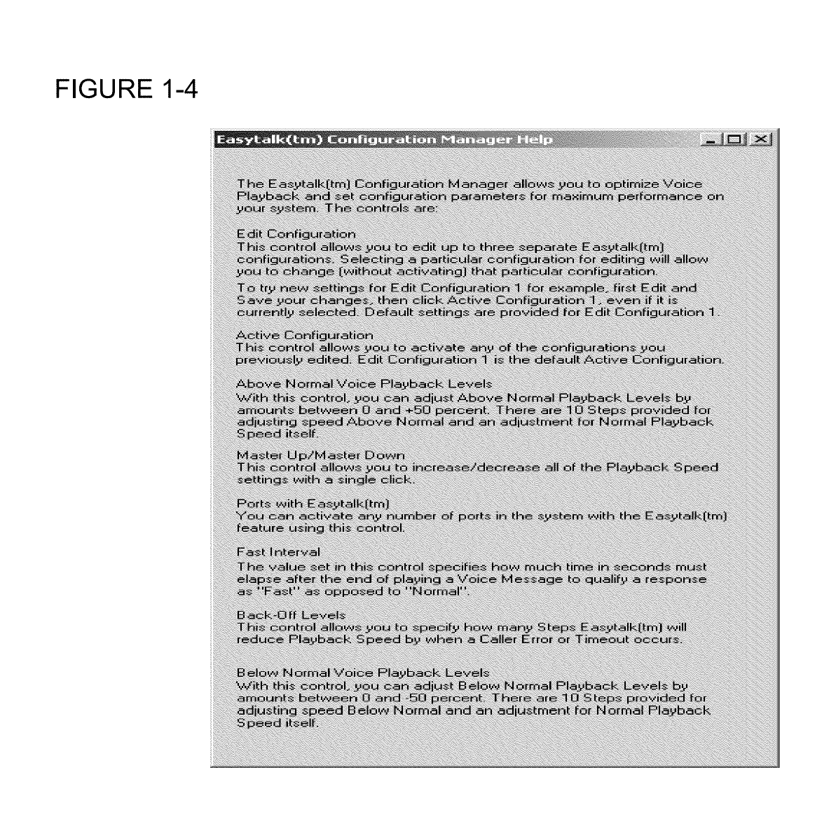

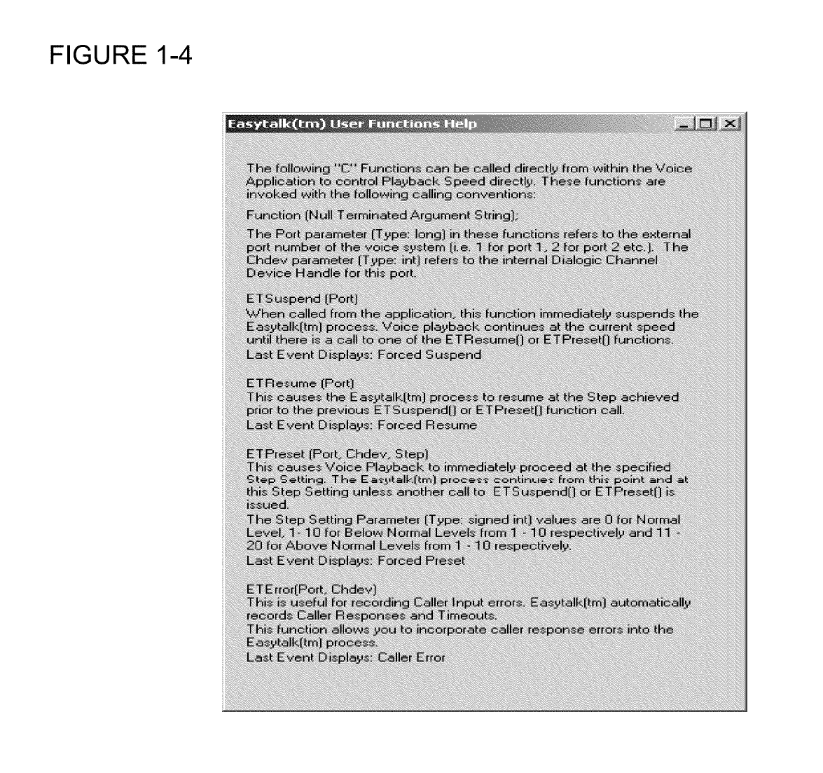

FIGS. 1-4 indicates how MCCS™ works during a Call Suspend Sequence, according to an embodiment.

FIG. 5 is Intel-Dialogic User Controls, according to an embodiment.

FIG. 6 is Avaya Configuration Screen, according to an embodiment.

### DETAILED DESCRIPTION OF THE INVENTION

The system monitors how quickly and accurately the user is responding via the input device. The input device can be a mouse, a keyboard, their voice, a touch-screen, a tablet PC writing instrument, a light pen or any other commercially available device used to input information from the user to the PBCD. Information is displayed on the PBCD screen based on how quickly and accurately the user is navigating with the input device.

If, for example, the user points and clicks on PC icons quickly and moves from window to window with speed, the screens and windows would pop up rapidly. Slower users would get a delayed or scrolled window display. In other words, the visual output rate of the PBCD is controlled based on the speed and accuracy of the user input.

Another enhancement to the visual output rate includes controlling screen transitions (how the display changes from one “window” or screen to the next) based on how proficient the user is at navigating the screens with whatever input device being used, including heir voice. I mean transitions here in the same way as digital movie transition effects such as fade in/fade out, slide in from top/left, dissolve, pixilated, etc. The idea is that the visual rate of change and means of change is matched and co-coordinated with what the PBCD senses as the users abilities, skills and moods so as to produce a visual output that is more in harmony with the user, thereby producing better communication results visually for the user.

Another enhancement of this idea is to change the actual visual content based on the sensed skill and mood of the user. For example, as a user navigates via pointing and clicking on windows type icons on a PBCD, the icons that are used most often are displayed larger and placed in more visually prominent area of the screen to the eye, based on frequency of use. Another example would be where text on a screen is displayed in larger or smaller fonts with bolding, underline and color used for emphasis based on user input. Yet another example is where the text content itself is regulated based on how the user is responding.

To summarize, visual output of a PBCD is regulated, controlled and modified based on the speed, accuracy and navigating abilities of the PBCD user as detected by the PBCD itself. Software (and possibly hardware) is added to the PBCD to accomplish the detection and control the visual output accordingly. The same means for collecting historical data based on past responses as described in my “ VoiceXL for VXML” provisional patent can also be used here as can other previously protected ideas for determining how to control the PBCD output.

Improvements
Use of APT for Voice Interaction with computers in local environments such as PC's, Workstations, Portable, Wearable, Laptop and Handheld Computers and mainframe computers.
Use of APT™ for voice communications over the Web, Internet, Intranets or other networks.
Use of ANI (Automatic Number Identification) to identify telephone callers to Voice Response Systems and use this ANI to select an appropriate voice playback speed known to match or suit that of the caller.
Use of APT™ to slow down voice playback rates for slower callers.
Use of APT™ to increase or decrease the playback volume of voice messages to callers based on their responses. Slow or erroneous caller responses to the voice response system (VRS) may result in slower playback of voice messages at a louder decibel volume.
Use of APT™ for alternately worded voice messages and/or alternate inflection or nuance in the played messages based on caller/local user responses. For example, an error or timeout response may cause a more encouraging, softly worded and sympathetic response. Correct and/or speedy responses would produce more affirmative responses.
Use of APT™ with voice recognition systems. Detecting via the speech recognition engine distress, confusion, certainty, boredom or other human response and adjusting the tone, nuance, content, volume, playback speed or other characteristic of voice system messages accordingly.
Use of APT™ to gather statistics on caller/user response times, error responses, good responses etc and present this info in a format which allows one to easily understand where callers/users are responding well or poorly. This could include a dialogue tree with response data for each branch such as time to respond, error count etc. This info can be used to make improvements in the caller/user interaction dialogue.
Use of APT™ with ANI or caller/user PIN or other ID to use their name and other personal information in voice system responses for a more personal touch.
Use of APT™ to go to manual mode and force voice playback at fixed playback speed and/or other playback characteristics for specific voice messages in the voice interaction dialogue.

1. Introduction

It is only in the last few years that the voice communications industry has focused its attention on improved VUI Design, Adaptive Caller Interfaces and User Personalization. APT™ provides an important improvement over these technologies in a simple, unique and effective way.

APT™ is an add-on software package for telephony voice applications. The product automatically personalizes the call experience by dynamically adjusting the voice playback rate (words spoken per minute) of pre-recorded audio prompts in response to how well a caller is navigating the call script in real-time.

This is a fully automatic software process that allows voice applications to adapt to users on a “per call” basis. User profiles, ANI codes and extra dialog steps are not required. The product operates in true anonymous real-time mode—any caller from any telephone will benefit from APT™ technology.

APT™ is the only voice technology that uses Adaptive Voice Playback™ for real-time personalization of telephone calls. The process is continuous throughout each call and automatically provides benefits regardless of what other adaptive voice technologies are deployed on the platform.

The product has a proven track record for improving IVR containment rates and reducing call duration. When configured for improved IVR containment, an increase of 1-5 percent of calls handled in the IVR can be expected. If shorter call durations are the goal, expect about a 6 second savings on a 90 second script. In general, the more levels of scripting and the higher the average IVR call duration, the greater the savings. This translates into significant cost savings since speech and touch-tone automated calls average $0.75 each to answer while agent handled calls are about $4.25 on average.

APT™ can be implemented on virtually any Voice Platform including VMXL and SALT Based Distributed Solutions, Networked ASP's and most proprietary on-premise IVR's.

2. Technology Background

The primary objective of a well-designed voice application is to allow callers to self-direct their telephone calls. For this process to be worthwhile for the caller, they must be able to navigate the application using their voice or touch-tone as an effective and efficient input device. To the extent this objective is not achieved, a direct proportion of callers will simply opt out of the system and wait for an agent.

Today's web based voice applications provide a wide variety of information to callers. Each application is unique in its overall length and complexity. In addition, each script level has its own unique context and difficulty level for the caller. While most callers have little trouble remembering the first five digits of their social security number, many may not easily remember which PIN they used for a specific account or what the account number itself is.

To further complicate matters, some callers will be using your voice application from the comfort and relative quiet of their own home or office. Others will be calling from a noisy public phone or a cell phone with a poor connection. Callers are people, so they rarely behave the same way day after day over the long periods of time your voice application will be used to answer their calls. Even seasoned power users will get distracted under certain calling conditions.

When you consider finally that individual callers will respond to voice prompts at their own pace and comfort level based on their navigation skills and ability to comprehend the call script at a particular time, it is clear that interaction with today's voice systems is truly an individual centered, situation based process.

3. The Adaptive Algorithm

With APT™, spoken and/or touch tone responses are continuously monitored in real-time to determine how quickly and accurately callers are navigating the voice application, node-by-node in the IVR Call Script.

The product then automatically speeds up the voice playback rate (words spoken per minute) and/or changes the content of the next voice segment in the call script if a caller responds quickly and accurately, and slows it down if a caller's input is slow or contains errors. This process continues throughout the life of each call and for every Call Script Node (CSN) to the voice application, essentially personalizing the call experience in real-time.

APT™ lets the system administrator configure different speeds for voice playback. Auto-Calibration mode, as described in section 4.2.2, allows the process to account for the uniqueness inherent in each voice application and how well a specific calling base navigates the call script. During this phase, the product tracks and logs how long it takes callers to respond to each CSN in the call script and uses this information to make intelligent decisions regarding when and how to adjust voice playback rate and/or content as the call progresses.

Before describing the APT™ Software Architecture, it is important to understand some of the components, concepts and measurements the process uses to accomplish adaptive functionality. These include:

APT™—Audio Builder Service (ABS)

ABS is a daemon process that continuously and without human intervention monitors the existing voice applications audio directory—the location of the applications pre-recorded audio files. As newly recorded voice segments are added to this audio directory by the application developer, the ABS automatically updates its audio database with the audio files required for APT™.

APT™—Application Programming Interface (API)

All of the functionality required to optimize a voice application with APT™ is contained in the API software component. The methods within this module are called from the voice application to control adaptive voice playback where needed throughout the application call script.

Alternate Speed Audio (ASA) files—For voice platforms that do not support dynamic playback control of the audio stream at the hardware DSP level, ASA files are needed by APT™ in order to accomplish Adaptive Voice Playback™. These ASA files are automatically generated and maintained by the APT™ ABS component (described in Section 4.1 below) in a manner that is completely transparent to the application developer and voice system administrator. The ABS will automatically generate and maintain ASA versions of all recorded segments in the existing applications audio directory based on data contained in the ABS configuration file. There is no distortion, pitch change or degradation in the quality of these ASA files; they play just like the originals only slightly faster or slower in terms of words per minute spoken. Typical values for ASA versions of these segments are 110, 114, 117 and 119 percent of the original 100 percent recordings.

Absolute Playback Speed (APS)—This is defined as a flat percentage of the original recorded voice files playback speed. The original recorded playback speed of the voice applications existing prompts is always defined as 100 percent APS. The ASA files required for a APT™ implementation always have an APS of between 50-150 percent. Typical APS values of ASA files for an implementation are 110, 114, 117 and 119 percent.

Relative Playback Speed (RPS)—This is an integer that designates a particular APS. In the example above, 110 is the APS value for RPS 1, 114 is the APS value for RPS 2 and so on.

Instantaneous Skill Level (ISL)—This is defined as how quickly the caller responds accurately to the current CSN relative to other callers. The real-time data APT™ uses to categorize caller ISL's is collected in the APT™ Auto-Calibration Mode.

ISL4—Expert or Power User: This ISL is achieved by a caller that has a response time for a given CSN that is in the top 20 percentile. For example, lets assume that 20 percent of callers to your application can successfully enter a nine-digit bank account number in 6 seconds or less. A caller that can do this in 6 seconds or less is classified as Expert or ISL4 for this particular CSN.

ISL3—Experienced: The caller is categorized at the 21-40 percentile ISL.

ISL2—Skilled—The caller is categorized at the 41-70 percentile ISL.

ISL1—Novice—The caller is categorized at the 71-100 percentile ISL.

ISLO—Inexperienced—The caller causes Input Errors, Timeout's and/or Help requests.

Established Skill Level (ESL)—This is defined as the skill level the caller has established as they progress through the call. The ESL is function of the combined ISL's achieved by the caller up to any given point in the call.

It is important to note that ESL status has to be earned by a caller first and then maintained throughout the call in order to retain its established level. Table 1 below indicates a typical relationship between the current RPS of a caller, the most recent ISL achieved by the caller and the subsequent change in RPS the APT™ process provides. These values constitute the Playback Speed Modification (PSM) table values used to determine playback adjustment.

TABLE 1
Typical APT ™ PSM Table Values
Most recent ISL achieved by caller

| Current RPS | ISL0 | ISL1 | ISL2 | ISL3 | ISL4 |
|---|---|---|---|---|---|
| RPS0 (85%) | 0 | 0 | 1 | 2 | 2 |
| RPS1 (90%) | −1 | 0 | 1 | 2 | 2 |
| RPS2 (95%) | −2 | −1 | 0 | 1 | 2 |
| RPS3 (100%) | −2 | 0 | 1 | 2 | 2 |
| RPS4 (110%) | −1 | 0 | 1 | 1 | 2 |
| RPS4 (114%) | −1 | 0 | 1 | 1 | 2 |
| RPS4 (117%) | −2 | 0 | 1 | 1 | 2 |
| RPS4 (119%) | −2 | 0 | 0 | 1 | 2 |
| RPS4 (121%) | −2 | 0 | 0 | 0 | 1 |
| RPS4 (123%) | −2 | −1 | 0 | 0 | 0 |

4. Software Architecture

APT™ is implemented as standardized software components that interface with the voice platforms native development and run time environments. Which version of the product is used depends on the software resources available the application at run-time. The developer uses these components to optimize existing applications with the APT™ process.

The key components to the package are the APT™ Audio Builder Service and the APT™ Adaptive Playback Service. For the purposes of the following specification, we will assume that this is a J2EE implementation of APT™. The programming constructs and methodologies are similar for JavaScript, C Language and other implementations of the product.

4.1 APT™—Audio Builder Service (ABS)

In order to provide Adaptive VoicePlayback™ of existing voice segments within the application, a mechanism to vary the pace of pre-recorded voice segments is required. Some voice platforms (including Intel-Dialogic, NMS Communications and Avaya) allow for dynamic control of the voice playback stream at the DSP hardware level. For platforms that do not support this feature, we provide the APT™ ABS software component.

ABS is a daemon process that continuously and without human intervention monitors the existing voice applications audio directory—the location of the applications pre-recorded audio files. As newly recorded segments are added to this audio directory by the application developer and/or recording personnel, ABS automatically updates its audio database with the ASA files required by the APT™ Application Programming Interface described in the next section.

The ABS will automatically generate alternate speed versions of all recorded segments in the existing applications audio directory based on data contained n the ABS configuration file. This is a flat text file that can be edited by the APT™ administrator and has the following format:

| | |
|---|---|
| SourceAudio | // source directory - the path to the existing audio directory |
| TargetAudio | // target directory path for ASA files to be generated |

| | |
|---|---|
| 1000 | // Auto-Cailbrate Call Sample Size (1000 Calls) |
| 110 | // APS for RPS 1 |
| 114 | // APS for RPS 2 |
| 117 | // APS for RPS 3 |
| 119 | // APS for RPS 4 |

...etc.

There is no distortion, pitch change or degradation in the quality of these alternate speed versions of the original recordings and they play just like the originals only slightly faster or slower in terms of words per minute spoken.

Typical values for alternate speed versions of these segments are 110, 114, 117 and 119 percent of the original 100 percent recordings. While higher and lower speeds are available, the vast majority of applications need vary only between 80-130 percent of normal playback speed for significant productivity gains in the IVR.

The current audio file formats supported are .wav, .au and .aiff files with 8/16 bit, mono and 8 KHz sample rates.

Associated Files:
/application/vl_abs.jar// APT ™ ABS JAR file
/application/vl_abs.txt// configuration file for APT ™ ABS
..where /application/ is the directory path of the existing voice application.

APT™—Application Programming Interface (API)

All of the functionality required to optimize a voice application with APT™ is contained in the API software component. The methods within this module are called from the voice application to control adaptive voice playback where needed throughout the application call script. What follows is a brief description of these methods and how they are used to improve voice application efficiency.

Call Origination/Termination

APT™ needs to know when a particular call is originated and terminated to allow for call session parameter setting and initialization. These method calls are made at the beginning and end of the application respectively.

Associated Files:
/application/vl_api.jar // APT ™ API JAR File
Associated methods:
vl_startofcall( )// signal the start of this call session
vl_endofcall( ) // signal the end of this call session

Auto-Calibration Mode

When the optimized voice application is initially run, it automatically enters Auto-Calibration Mode. Running in Auto-Calibration mode allows APT™ to gather the vital caller/application specific information inherent in any given call script. As the application executes in auto-calibrate mode with production call traffic, it gathers and builds the APT™ Response Timing Database. The RTD is data that tracks how long it takes for the initial sample of callers to navigate each CSN in the voice application call script.

The gathered information tells APT™ exactly how long for example, a specific caller base takes to correctly enter a nine digit account number or five digit PIN under the application specific calling conditions. It will be against these measurements that APT™ will determine whether to adjust voice playback for a specific caller at a particular CSN when running in production mode.

There are no speed adjustments in auto-calibrate mode and callers simply hear the application as it sounds without APT™.

Upon completion of the auto-calibration mode run, the application automatically cuts over to production mode and uses the data collected in the RHD to select the appropriate ASA file at each stage in the application script.

| | |
|---|---|
| Associated Files: | |
| /application/vl_api.jar | // APT ™ API JAR File |
| Associated methods: | |
| vl_calibrate( ) | // force APT ™ into Auto-Calibration mode |

Handling Caller Prompt/Filled Events

The vl_csnstart( ) function is called at the beginning of each voice prompt in the application. This signals the beginning of voice play for the next CSN in the application script.

When the caller triggers a corresponding FILLED event in the application, a call to the vl_csnfilled( ) method is made. Data collected in the Auto-Calibration phase of the application session is used by the vl_csnfilled( ) method to determine if this caller response warrants a change in voice playback speed.

Associated Files:
/application/vl_api.jar // APT ™ API JAR File
Associated methods:

| | |
|---|---|
| vl_csnstart( ) | // signals the beginning of voice play for current prompt |
| vl_csnfilled( ) | // signals a successful response to current prompt |

Handling caller NOINPUT, NOMATCH and HELP Events

APT™ provides functions to account for the effects the callers NOINPUT, NOMATCH, and HELP events will have on adaptive playback speed. These events are generally handled in the voice application itself by a single block or a limited number of blocks of code, thus simplifying APT™ method calls to the handlers for these events.

Typically, the application will temporarily and incrementally slow down playback when either a NOINPUT or NOMATCH event is received from the caller

When a HELP event is triggered by the caller, playback is set to normal (the original recorded rate) for the remainder of the call session as this caller is assumed to be a novice if they are asking for help with the application.

| | |
|---|---|
| Associated Files: | |
| /application/vl_api.jar | // APT ™ API JAR File |
| Associated Methods: | |
| vl_csnnomatch( ) | // signals a NOMATCH event received from the |
| | caller |
| vl_{——}csnnoinput( ) | // signals a NOINPUT event received from the |
| | caller |
| vl_csnhelp( ) | // signals a HELP request event received from the |
| | caller |

Using Audio Playback Presets for Playback Control

At certain points in the voice application script, it may be necessary to override the APT™ adaptive playback process. An example of this would be when playing back bank account balances, mailing addresses or telephone numbers. Even though a caller may have qualified themselves as a power user and may be listening to the application prompts at a faster rate, the application developer can force voice playback to slower or normal rates for these portions of the call.

Associated Files:
/application/vl_api.jar // APT ™ API JAR File
Associated Methods:
vl_preset( ) // force playback to a particular rate

| | |
|---|---|
| vl_resume( ) | // resume playback at previous APT ™ adjusted rate |

Application and APT™ Control Flow

The voice application developer inserts calls to the API methods in the application script itself. The vl_start method is called once on application start up to initialize APT™ from the parameters contained in the vl_configure.txt configuration file.

Table 2 below illustrates the typical calling sequence for the vl_api( ) user functions within a given voice application and phone call.

TABLE 2
Typical calling sequence for vl_api( ) user functions

| Application | | | |
|---|---|---|---|
| Start-Up | Vl_start( ) | | |
| New Call | Vl_callstart( ) | | |
| New CSN | Vl_csnstart( ) | Vl_calibrate( ) | Vl_filled( ) |
| New CSN | Vl_csnstart( ) | Vl_filled( ) | |
| Anytime | Vl_preset( ) | Vl_resume( ) | |
| New CSN | Vl_csnstart( ) | Vl_csnhelp( ) | |
| New CSN | Vl_csnstart( ) | Vl_csnnoinput( ) | |
| New CSN | Vl_csnstart( ) | Vl_csnnomatch( ) | |

5. Platform Considerations

While the IVR industry moves towards open standards like VoiceXML and SALT, older proprietary IVR systems continue to occupy a large share of the market for this equipment. These proprietary equipment vendors have been forced to integrate open standards into their platforms over the last few years. Currently, all major vendors support both open standards and the older proprietary architecture.

5.1 APT™ for VoiceXML

The APT™ ABS component for VXML based voice applications is implemented in Java and runs as a process daemon on the application server. All software required for the ABS is contained in the APT_ABS.jar file. This file is part of the APT™ install package.

All audio services required by the APT™ API are handled transparently by this J2EE compliant application. The ABS Configuration File contains initial parameters for the ABS including the audio source and target directories and initial playback speed settings for APT™.

The APT™ API component for VXML is implemented in JavaScript and linked in to the application via standard VXML scripting techniques as follows:

<script src=“/application/APT_api.js”/>. . . where /application/ is the directory path of the existing voice application.

The application developer invokes the APT™ process within the application by placing calls to the methods in the APT_api.js file. Caller events including NOINPUT, NOMATCH and HELP are typically handled in the VXML application via independent error handling code. This allows calls to the appropriate error handling methods in the API to be localized to that section of the application script.

Two method calls are needed per VXML form to use APT™. The first call is to the vl_csnstart( ) method and is placed at the start of the VXML form. The second call is to the vl_csnfilled( ) method and is placed as the first line of script within the VXML filled( ) body of script. Examples of these calls within the VXML application are as follows:

<script> vl_csnstart( ) </script>
<script> vl_csnfilled( ) </script>

This editing process can be applied to any number of VXML forms within the application script.

5.2 APT™ for J2EE Environments

The APT™ implementation for J2EE environments is very similar to that of VXML applications. The APT™ ABS component is the same APT ABS.jar file as used in the VXML implementation of APT™. Again, this application is implemented as a process daemon on the application server. The J2EE version of APT API is contained in the APT_api.jar file. This software provides a means for Java enabled voice applications to access the API methods described in section 4.

5.3 Intel-Dialogic Windows Applications

APT™ is provided as a Windows DLL for Intel-Dialogic based voice applications. The included software allows the system administrator to fine-tune APT™ for optimal performance on Voice Applications. Controls are provided for adjusting voice playback and content at each level in the call script.

5.4 Avaya Conversant and AIR Platforms

APT™ is provided as an install package for Avaya Conversant and AIR voice applications. Once installed on the system, the administrator can set playback levels and adjust configuration parameters for optimal performance. Call reports are used to track differences in call duration between ports with and without APT™.

5.5 Proprietary Voice Platforms

APT™ can be implemented for virtually any Voice Platform including Intervoice InVision, Aspect CSS, Nortel MPS/PeriProducer, Genesys GVP and Syntellect VistaGen to name a few. How the product is implemented on proprietary IVR platforms depends on the native architecture of the system and the run-time software resources available to the application.

1. Introduction

This document describes how the patented APT™ Process is implemented on VoiceXML based platforms. With this version of APT™, VXML application developers can now quickly and effectively implement the feature on their speech and touch-tone Interactive Voice Response (IVR) applications without the need to integrate third-party software on the IVR platform itself.

2. Technology Background

The primary objective of an IVR system is to allow your customers to self-direct their telephone calls. In order for this process to be worthwhile for the customer, they must be able to navigate though the call script using their voice or touch-tone as an efficient and effective input device. To the extent this objective is not achieved by the organization, a direct proportion of callers will simply opt out of the system and wait to speak to an agent.

IVR systems must also be designed to be easily navigable by first-time callers. In order for the first-time caller to have a successful interaction, prompts need to be comprehensive, outlining the full range of options to the caller. Complex IVR systems may have many layers of options and menus to navigate before the caller arrives at the information they need. Repeat or expert callers may become frustrated with the length of these option lists.

There are several ways of making IVR systems more navigable for the experienced user. These include allowing the caller to interrupt a prompt or menu with a selection or providing an option to bypass some of the prompts entirely. However, these options assume that the caller will always remember the available choices further along in the script.

The optimal solution for experienced, novice or distracted callers is one that enables your IVR to automatically and continuously adjust the voice playback speed of your existing prompts to suit each type of caller on each call to the IVR system. This allows the experienced caller to move quickly to the desired information while still offering all of the guidance information necessary for a successful connection for any caller.

3. How APT™ for VXML Works

APT™ is a caller adaptive process that continuously monitors the speed and accuracy with which each caller is responding to your IVR prompts and menus and adjusts the voice playback speed of subsequent prompts accordingly. Under APT™, you can set minimum, several intermediate, and maximum playback speeds for your IVR, as well as the caller response times that will trigger an appropriate change in playback speed.

Today's voice applications are often required to provide a variety of information to callers under a wide variety of call specific circumstances. Each voice application is unique in its overall length and the complexity of each level in the call script. A simple voice mail/auto-attendant application might only ask the caller to select departments within the organization or to specify a name or extension. A more complex voice application could ask the caller to enter an account number, a PIN and then offer several choices to the caller via multiple menus.

In addition, each level in the application script has its own unique context and difficulty level for the caller. Most callers have little difficulty remembering the first five digits of their social security number, but many may not easily remember which PIN they used for a specific account or what the account number itself is. And a five second long audio file that asks the caller for a nine digit account number will generally require more time for an accurate response than a ten second audio file that simply asks the caller to select from one of three alternative input choices.

To further complicate matters, some of your callers will be using your voice application from the comfort and silence of their own home or office. Others will be calling from a noisy public phone or a cell phone with a poor connection. Add to this the fact that individual callers will respond to the same question at their own pace and comfort level based on their ability and knowledge and it becomes clear that interaction with modern voice applications is truly an individual centered, situation based process.

In order to account for this uniqueness among specific voice applications, we provide a calibration mode for APT™. This allows your application to run in “Normal Mode” without APT™ in order to provide real-time feedback from your callers under live call circumstances. When your application runs with APT™ in calibration mode, there is no change in the playback speed of your audio and your callers hear the application as it sounds without APT™. However, the APT™ feature tracks and logs how long it takes your callers to respond in seconds to each question/response pair (or VXML form) in which the process was implemented. This provides the valuable, real-time information inherent in your application required to optimize APT™ for your particular call center operation.

APT™ is the solution to allow your callers to set their own pace for self-directed calls. This increases customer satisfaction while minimizing call duration. Automatic changes in playback speed enable your IVR system to adjust to the individual caller just as a human receptionist would. This increases efficiency for experienced callers while providing inexperienced callers with the support they need. Increasing the efficiency of your IVR system saves money in reduced toll-charges and higher call throughput via your IVR system. APT™ has been proven to reduce call duration by 5-15 percent of the overall call length based on the type of call script being used. For further information on how APT™ works, please visit our website at www.voicexl.com.

4. Implementation Design Stage

To begin the implementation process for a given VXML application, we first identify which script nodes in the application which will have the APT™ process. Not all script nodes may require or justify APT™ implementation and this can be done on a section of script at a time, starting with the 3-4 nodes that will produce the best results first. The primary factor to consider here is whether or not the call volume through the node itself is substantial enough to justify APT™ process implementation. FIG. 1 shows a typical first iteration of a APT™ implementation on a standard account balance inquiry application.

FIG. 1 is Retail checking/savings account implementation. APT™ script nodes shown in blue.

5. VXML Code Implementation of APT™

APT™ is implemented on VXML based platforms via changes to your pre-recorded audio files, the addition of our APT™ JavaScript code and changes to the VXML code itself.

5.1 Pre-Recorded Audio File Modifications

Once it is determined in the design stage which alternate speed audio files will be needed, off-line voice editing tools (such as CoolEdit® or Sound Forge®) are used to generate the alternate speed versions of these files.

These off-line sound editing tools change the playback speed of previously recorded .wav and other audio files by reducing or eliminating unnecessary elements of the playback stream. There is no distortion in the audio output stream and the file plays just like the original recording only slightly faster or slower in terms of words per minute spoken.

These alternate speed files are then placed in the audio directory containing the applications original audio files and named as shown in FIG. 2.

FIG. 2 is Alternate speed audio file naming convention.

Typical values for the alternate speed audio recordings are 110, 114 and 117 etc. percent of the original recorded speed but this varies by application and the speed of the original recording.

5.2 VXML Modifications

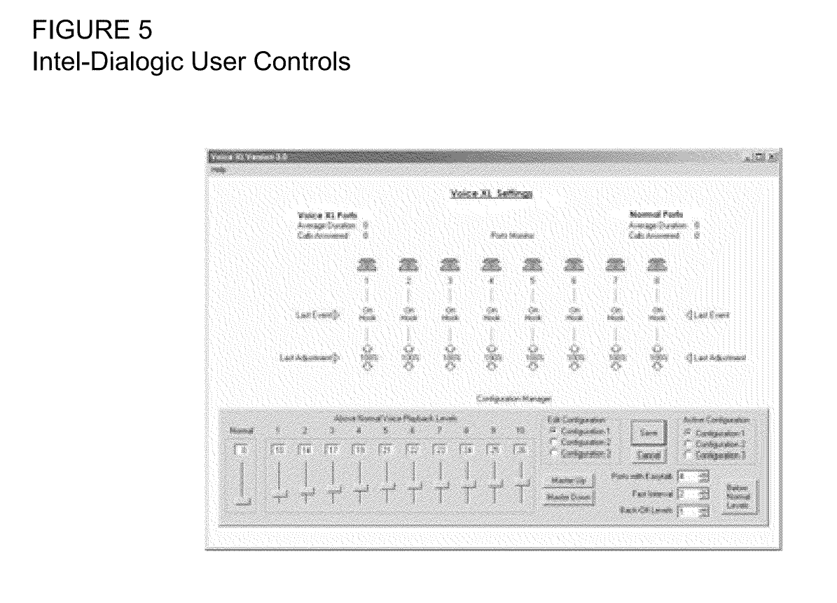

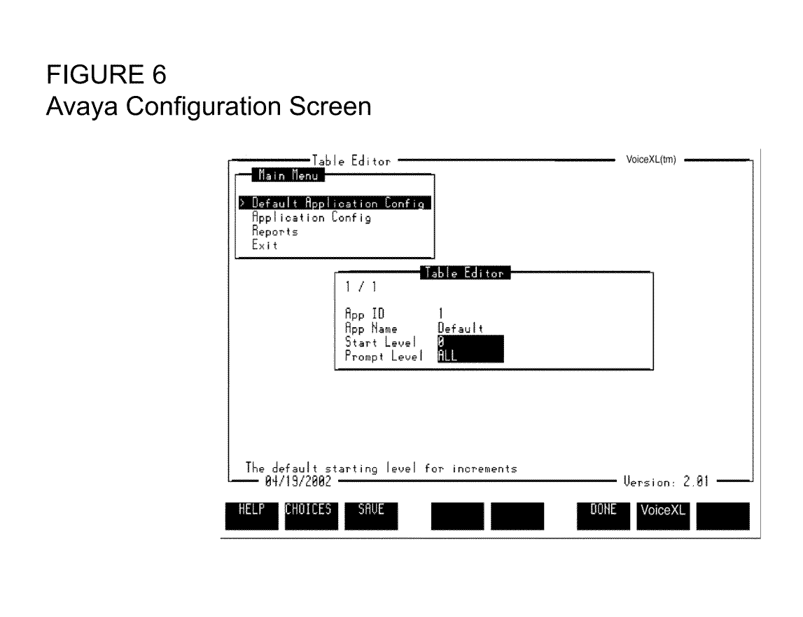

All APT™ functionality for your application is contained in the JavaScript file APT.js provided by Interactive Digital. Once added to your VXML code as a standard ECMAScript add-on, the functions within this module are called to control voice playback throughout the application. FIG. 3 shows a typical implementation in the account balance inquiry application discussed earlier. A step by step description of the implementation follows: FIG. 3 APT Implementation in VXML.

5.2.1 Add the JavaScript file APT.js to your VXML Code

To make the APT.js ECMAScript functions available to your application, add the following line to the root document of your VXML code:

<script src=“http://www.voicexl.com/APTjs”/>

5.2.2 Call vl_init( ) to initialize APT™

Place this function call in the VXML code that starts each session or call answered by the application. The function is called as follows:

vl_init(id increments, id_decrements)

The calling parameters are:
id_increments is the number of positive speed adjustments for this implementation
id_decrements is the number of negative speed adjustments

5.2.3 Update the Application <Audio> Tags

In order to allow for dynamic selection of the appropriate audio file, replace all <audio> tags that will incorporate the APT™ process in the VXML application as follows:

<audio src=“‘http://www.voicexl.com/audio/filename.wav”/>
with:
<audio expr=“‘http://www.voicexl.com/audio/’ +
vl_play(‘filename.wav’)”/>

5.2.4 APT™ Event Handlers

APT™ provides functions to account for the effects your applications NOINPUT, NOMATCH, HELP and FILLED events will have on playback speed.

5.2.4.1 Typically, you will want the application to temporarily and incrementally slow down playback when either a NOINPUT or NOMATCH event is received from the caller. In order to do this, place calls to the vl_noinput( ) and vl_nomatch( ) functions at the corresponding handlers for these events as shown in FIG. 3.

5.2.4.2 When a HELP event is triggered by the caller, playback is set to normal playback (the original recorded rate) for the remainder of the session as this caller is assumed to be a novice if they are asking for help with the application. In order to do this, place calls to the vl_help( ) function at the corresponding handlers for this event as shown in FIG. 3.

5.2.4.3 When the caller triggers a FILLED event in the application, the primary function of APT™ is invoked causing a change in voice playback speed based on the relative speed of the callers response. In order to do this, place calls to the vl_filled( ) function at the corresponding handler for this event as shown in FIG. 3.

6. Run the Application with APT™ in Calibration Mode

With APT™ now implemented in your voice application, you will need to run some calibration tests in order to optimize the process for best results. Running APT™ in calibration mode allows you to gather the vital caller/application specific information inherent in your IVR implementation. This information tells you exactly how long for example, your specific caller base takes to correctly enter a nine digit account number under their specific and typical calling conditions. It will be against these measurements that APT™ will determine later whether to adjust voice playback for a specific caller at a particular stage in the call script when running in production mode.

In order to run your application in calibration mode, simply call the vl_init( ) JavaScript function as follows:

vl_init(0,0)

You can let the application run for as long as it takes to complete a reasonable number of calls (ten is a good minimum sample here), then observe your log files to see what the response times of each caller at each script level is. Make note of the “filled” response times and compute the average for use in your application production run.

6. Run the Application with APT™ in Production Mode

Upon completion of the calibration mode run, you will have enough data specific to your application to allow you to fine tune the APT™ response parameters for optimal performance of your application. Use this data to call each vl_filled( ) JavaScript function as follows:

### Vl_filled(FieldAverage)

Where FieldAverage is the average response time for this field as computed in the Calibration Run above. With these parameters in place for each call to the the vl_init( ) function, you can now run the application now with APT™ tuned for optimal performance.

7. Auto-Calibration Mode and Server Data Storage

When the pilot phase for APT™ has been completed and it is time to make APT™ part of your overall IVR deployment strategy, an additional feature is available to further automate the calibration process.

Auto-calibration mode allows your voice applications to be automatically tuned for optimal performance based on calibration parameters the user sets prior to running the application.

Based on the version of VoiceXML being used and the client/server restrictions on the use of HTTP cookies, the Caller Responses information is stored on the application server and used to determine when to adjust voice playback during calls to the vl_filled( ) function.

FIGS. 1-4 This figure indicates how MCCS™ works during a Call Suspend Sequence.

1. (canceled)

2. A method, comprising:
transmitting content to a user interface, the content having a set of characteristics;
receiving from the user interface, an interaction signal in response to the content; and
changing at least a portion of the set of characteristics of the content transmission to a modified set of characteristics when the interaction signal is determined to meet a criteria.

3. The method of claim 2, further comprising assigning a skill level based on the interaction signal, the second set of characteristics being associated with the assigned skill level.

4. The method of claim 2, wherein the set of characteristics of the content transmission includes at least one of a transmission rate, a tone, an inflection, an audio volume or a content of the message.

5. The method of claim 2, wherein the set of characteristics includes a first transmission rate, the modified set of characteristics includes a second transmission rate that is one of slower or faster than the first transmission rate when the interaction signal is determined to be at a speed below or above a defined threshold.

6. The method of claim 2, wherein the set of characteristics includes a first transmission volume of the transmitted content, the modified set of characteristics includes a second transmission volume when the interaction signal is determined to be one of within our outside a set of criteria.

7. The method of claim 6, wherein the interaction signal is one of a signal indicative of a lack of response within a predetermined time period or a signal indicative of ambient noise at the user interface.

8. The method of claim 2, wherein the set of characteristics includes a first transmission inflection, the modified set of characteristics includes a second transmission inflection.

9. A method, comprising:
receiving data associated with a first telephone call at a first time, the data including at least a portion of a user identifier;
storing historical information about interaction data received during the first telephone call and associating the historical information with the portion of the user identifier; and
based on the historical information associated with the user identifier, transmitting content using a set of predefined characteristics during a second telephone call at a second time when received data associated with the second call includes at least the portion of the user identifier.

10. The method of claim 9, wherein the portion of the user identifier is further associated with a predefined set of characteristics including at least one of a content transmission rate, a content transmission volume, an inflection, a tone or a content of the message.

11. The method of claim 9, wherein the user identifier is at least a portion of an Automatic Number Identification (ANI), the at least a portion of the ANI being one of an area code or a ten-digit telephone number.

12. The method of claim 9, wherein the user identifier is at least a portion of an account number.

13. The method of claim 9, further comprising:
receiving input during the second telephone call at a speed that is slower than a predetermined threshold; and
based on the receiving, transmitting the content at a rate slower than a predetermined rate.

14. An apparatus, comprising:
a user interface system configured to communicate with a user device, the user interface system including a processor and a memory, the interface system configured to
modify a functionality of the user interface system in response to a change in a duration of actuating an actuator coupled to the user device; and
maintain the functionality of the user interface system in response to no change in the duration of the actuating.

15. The apparatus of claim 14, wherein the interface system includes an interactive voice response system.

16. The apparatus of claim 14, wherein the user device is one of a telephone, a wireless phone or a computer.

17. The apparatus of claim 14, wherein the functionality is a speed of content transmission.

18. A non-transitory processor-readable medium storing code representing instructions to be executed by a processor, the code comprising code to cause the processor to:
transmit content to a user interface, the content having a set of characteristics;
receive from the user interface, an interaction signal in response to the content; and
change at least a portion of the set of characteristics of the content transmission to a modified set of characteristics when the interaction signal is determined to meet a criteria.

19. The non-transitory processor-readable of claim 18, further comprising code to cause the processor to assign a skill level based on the interaction signal, the second rate being associated with the assigned skill level.

20. A non-transitory processor-readable medium storing code representing instructions to be executed by a processor, the code comprising code to cause the processor to:
receive data associated with a first telephone call at a first time, the data including at least a portion of a user identifier;
store historical information about interaction data received during the first telephone call and associating the historical information with the portion of the user identifier; and
based on the historical information associated with the user identifier, transmit content using a set of predefined characteristics during a second telephone call at a second time when received data associated with the second call includes at least the portion of the user identifier.

21. The non-transitory processor-readable medium of claim 20, wherein the portion of the user identifier is further associated with a predefined set of characteristics including at least one of a content transmission rate, a content transmission volume, an inflection, a tone or a content of the message.

22. The non-transitory processor-readable medium of claim 20, further comprising code to cause the processor to receive input during the second telephone call at a speed that is slower than a predetermined threshold; and
based on the receiving, transmit the content at a rate slower than the predetermined rate.
